(19) United States
(12) Patent Application Publication
(10) Pub. No.: US 2010/0299746 A1
(43) Pub. Date: Nov. 25, 2010

(54) PASSWORD PROTECTION SYSTEM

(75) Inventor: WEN SHU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/732,143

(22) Filed: Mar. 25, 2010

(30) Foreign Application Priority Data
May 20, 2009 (CN) 200910302474.0

(51) Int. Cl. H04L 9/32

(52) U.S. Cl. 726/18

(57) ABSTRACT

A password registering method used in an electronic device includes generating and outputting indicating information according to at least one program as an indicating command executed to indicate the user to input a password; detecting and outputting first input information, recording a first time value when the first input information is detected; detecting and outputting second input information, recording a second time value when the second input information is detected; recording time period between the first time value and the second time value; generating password information according to the input operations and the time period; and registering the password information as a password to unlock the electronic device. A password protection method for unlocking the electronic device and the electronic device are also provided.

### BACKGROUND

1. Technical Field

The disclosure relates to information security field, and more particularly to a password protection system.

2. Description of Related Art

Password protection is already widely used in daily life, such as in computers, mobile phones, automatic teller machines, etc. Usually, a combination of numbers and characters are used as a password. However, unauthorized users can use certain software to crack the password, thereby obtaining unauthorized access.

Therefore, it is necessary to provide a password protected system to avoid password cracking.

### BRIEF DESCRIPTION OF THE DRAWINGS

The components in the drawing are not necessarily drawn to scale, the emphasis instead being placed upon clearly illustrating the principles of the password protection system.

FIG. 1 is a block diagram of a password protection system of an exemplary embodiment of the present disclosure.

FIG. 2 is a block diagram showing the internal configuration of a control unit in the password protection system of FIG. 1, in accordance with an exemplary embodiment.

FIG. 3 is a flowchart implementing the password protection system in an exemplary embodiment of the present disclosure.

### DETAILED DESCRIPTION

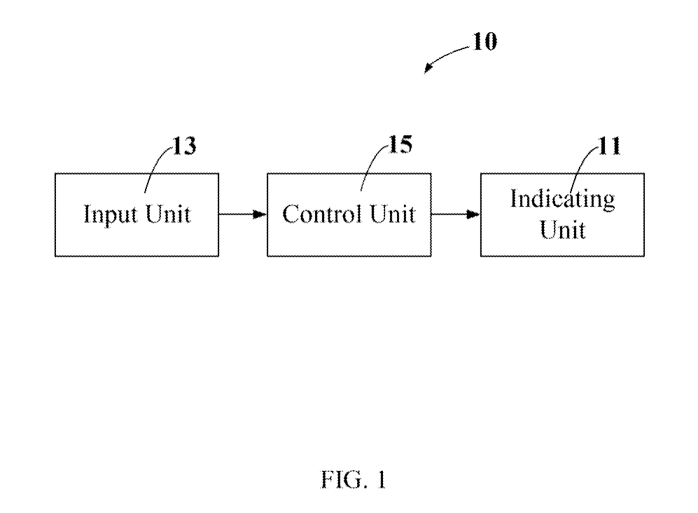

FIG. 1 is a block diagram of a password protection system of an exemplary embodiment of the present disclosure. The password protection system is stored in an electronic device 10 in a form of computer-executable program codes. When the electronic device 10 is activated, the program codes are executed by a processor of the electronic device 10 to implement the function of password protection. The electronic device 10 may be a touch-screen phone, a personal digital assistant (PDA), an automatic teller machine (ATM), etc.

The password protection system includes two working modes, i.e., registering a password, and unlocking the electronic device 10. A user registers the password when he wants to use the password protection system to protect his private information. After registering the password, if he wants to unlock the electronic device 10, he should input correct operations to unlock the electronic device 10.

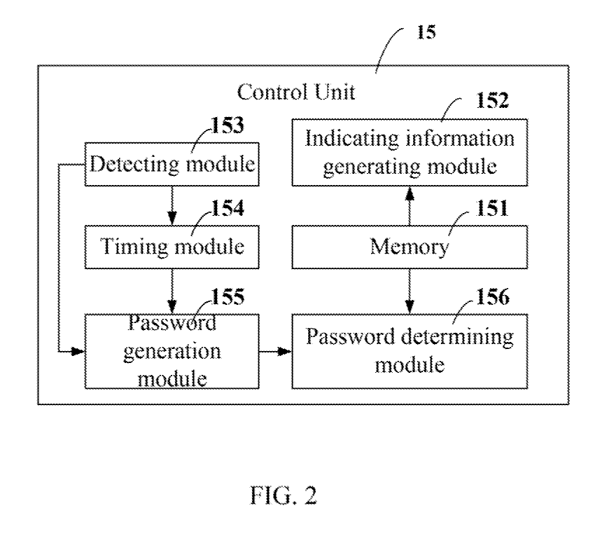

As shown in FIG. 1, the password protection system includes an indicating unit 11, an input unit 13, and a control unit 15. The indicating unit 11 is configured for generating and outputting signals to prompt user inputs. The indicating unit 11 may be a display or a speaker. The input unit 13 is configured for receiving user's input and generating corresponding input information. The input unit 13 may be a microphone or a touchpad. The control unit 15 is described in detail together with FIG. 2.

FIG. 2 is a block diagram showing the internal configuration of a control unit in the password protection system of FIG. 1, in accordance with an exemplary embodiment. The control unit 15 includes a memory 151, an indicating information generating module 152, a detecting module 153, a timing module 154, a password generation module 155, and a password determining module 156.

The memory 151 is configured to store at least one program as an indicating command to be executed to indicate the user to input information. The indicating command is pre-stored and implemented by the electronic device 10.

The indicating information generating module 152 is configured to generate and output indicating information to the indicating unit 11 according to the indicating command. For example, if the indicating command is timed in seconds, the electronic device 10 will display time elapsed in seconds or beeps in seconds according to the indicating command. Once one password has been registered, the memory 151 further stores the registered password.

The detection module 153 is configured to detect input information generated by the input unit 13, output the detected information to the password generation module 155, generate and output a timed signal to the timing module 154.

The timing module 154 is configured to time the inputted password with timed signals, for example, if the users password is 1111, the user must input the sequence with a timed period between the different numbers, (i.e. 1-pause-1-pause-1-pause-1-pause). The timing module 154 records the time periods between successive input operations, and sends the time periods to the password generation module 155.

The password generation module 155 is configured to generate the password information according to the input information operation and the time periods. The password information includes the time periods between successive input operations. The number of implementing the input operation is more than 2. For example, if the user inputs letter A at 00:00:01 s, letter B at 00:00:03 s, and letter C at 00:00:05 s, the password information will include A, B, C, time periods 2 s between inputting A and B, and time period 2 s between inputting word B and C. The number of implementing the input operation is 3 in the example. When the password is first registered, the time periods between inputs are also included as password information.

The password determining module 156 is configured to compare the generated password information with the registered password stored in the memory 151 to determine whether input operation is correct.

The input unit 11 further includes a button for confirming to register the generated password information as the password to be further stored in the memory 151. The button is further configured for confirming to end input operation. The button may be a physical hardware button or a software button generated by software.

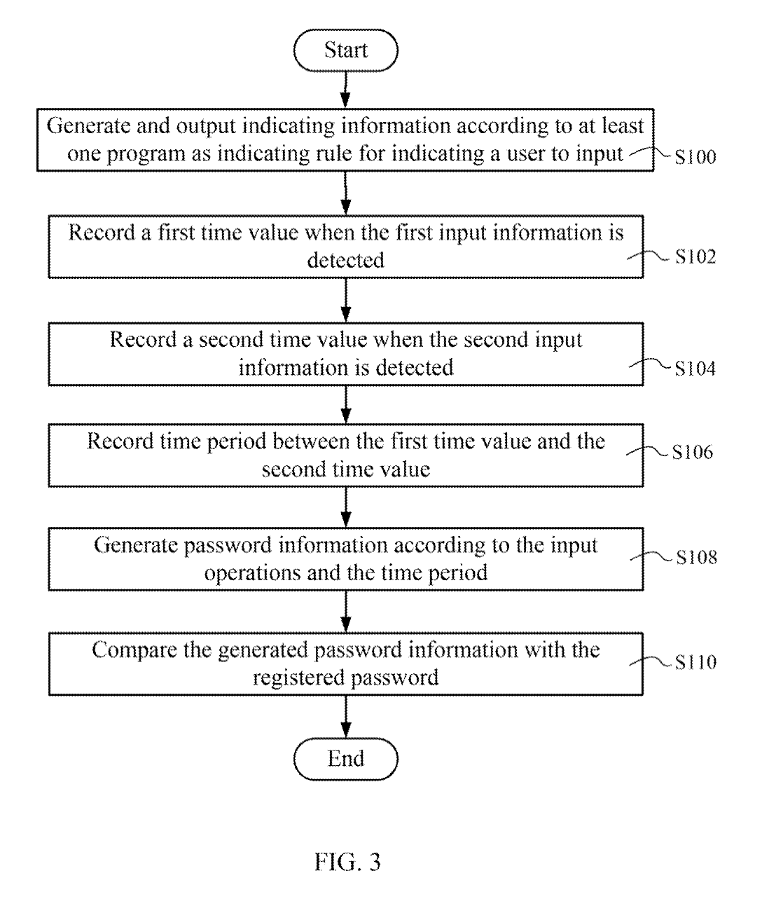

FIG. 3 is a flowchart implementing the password protection system in an exemplary embodiment of the present disclosure. The following procedure is an example of how to unlock the electronic device 10. In order to explain the inventive concept in a simple way for easy understanding, the following disclosure of FIG. 3 takes two implemented input operations for example, that is, the password information is generated according to a first input operation and a second input operation and the time period between the first input operation and the second input operation.

In step S100, the indicating information generating module 152 generates and outputs indicating information to the indicating unit 11 according to the indicating command.

In step S102, the detection module 153 detects first input information generated by the input unit 13 and outputs the detected first input information to the password generation module 155. The timing module 154 records a first time value when the first input information is detected.

In step S104, the detection module 153 detects the second input information generated by the input unit 13 and outputs the detected second input information to the password generation module 155. The timing module 154 records a second time value when the first input information is detected. For example, the user inputs when the indicating unit 11 displays 1 s, the value of 1 s will be recorded as the first time value; the user inputs the second time when the indicating unit 11 displays 5 s, the value of 5 s will be recorded as the second time value.

In step S106, the timing module 154 records the time period between the first time value and the second time value.

In step S108, the password generation module 155 generates password information according to input operations and the time period between the first time value and the second time value.

In step S110, the password determining module 156 responds to operation of confirming to end input operation, compares the generated password information with the registered password stored in the memory 151 to determine whether the input operation is correct. The electronic device 10 is unlocked when the input operation is correct.

The method of registering password is similar with unlocking the electronic device 10, except that step S110 instead registers the password information as a password to unlock the electronic device.

By utilizing the password protection system as described above, which is different by adding a time period to the traditional fixed combinations of numbers and letters. Unauthorized users cannot easily crack password with software, thus effectively protecting the user's information.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A password registering method used in an electronic device, the method comprising:
generating and outputting indicating information according to at least one program as an indicating command executed to indicate the user to input a password;
detecting first input information and outputting the detected first input information, recording a first time value when the first input information is detected;
detecting second input information and outputting the detected second input information, recording a second time value when the second input information is detected;
recording time period between the first time value and the second time value;
generating password information according to the input operations and the time period; and
registering the password information as a password to unlock the electronic device.

2. The password registering method according to claim 1, wherein the method further comprises a step of confirming to register the generated password information as password.

3. The password registering method according to claim 1, wherein the generating password information further comprises number of implementing the input operations.

4. The password registering method according to claim 3, wherein the number of implementing the input operation is two or more.

5. A password protection method for unlocking an electronic device, the method comprising:
generating and outputting indicating information according to at least one program as an indicating command executed to indicate the user to input a password;
detecting first input information and outputting the detected first input information, recording a first time value when the first input information is detected;
detecting second input information and outputting the detected second input information, recording a second time value when the second input information is detected;
recording time period between the first time value and the second time value;
generating password information according to the input operations and the time period; and
comparing the generated password information with the registered password.

6. The password protection method according to claim 5, wherein the method further comprises a step of confirming to end input operation.

7. The password protection method according to claim 5, wherein the generating password information further comprises number of implementing the input operations.

8. The password protection method according to claim 7, wherein the number of implementing the input operation is two or more.

9. The password protection method according to claim 5, wherein the method further comprises a step of unlocking the device when the input operation is correct.

10. An electronic device using a password protection method, the electronic device comprising:
an indicating unit configured for generating and outputting signals to prompt user inputs;
an input unit configured for sensing user's input operations and generating corresponding input information;
a memory configured for storing at least one program as an indicating command executed to indicate the user to input a password;
an indicating information generating module configured for generating and outputting indicating information to the indicating unit according to the at least one indicating command;
a detection module configured for detecting input information generated by the input unit, outputting the detected input information to a password generation module, generating and outputting a time signal to a timing module each time input information is detected;
the timing module configured for timing when the time signals are received, recording time period between successive input operations, and sending the time period to the password generation module; and
the password generation module configured for generating password information according to the received input information and the time period.

11. The electronic device according to claim 10, wherein the electronic device further comprises a button for confirming to register generated password information as password, and the memory is further configured for storing the registered password.

12. The electronic device according to claim 10, wherein the memory is further configured for storing a registered password, and the electronic device further comprises a password determining module configured for comparing the generated password information with the registered password to determine whether input operation is correct.

13. The electronic device according to claim 10, wherein the electronic device further comprises a button configured for confirming ending inputting operation.

14. The electronic device according to claim 13, wherein the button is a physical hardware button or a software button.

15. The electronic device according to claim 10, wherein the indicating unit is a display or speaker.

16. The electronic device according to claim 10, wherein the input unit is a microphone or a touchpad.

17. The electronic device according to claim 10, wherein the password generation module is further configured for generating password information according to number of implementing the input operations.
